(19) United States
(12) Patent Application Publication
(10) Pub. No.: US 2014/0191099 A1
(43) Pub. Date: Jul. 10, 2014

(54) Mobile Holder

(71) Applicant: Michael Anthony Schwarz, San Jose, CA (US)

(72) Inventor: Michael Anthony Schwarz, San Jose, CA (US)

(21) Appl. No.: 13/737,395

(22) Filed: Jan. 9, 2013

(51) Int. Cl. F16M 13/00; F16M 13/04

(52) U.S. Cl. CPC F16M 13/005; F16M 13/04
USPC 248/309.1; 294/137

(57) ABSTRACT

The first embodiment of the present invention presents a mobile device holder that is comprised of four components: a single finger holder, a single finger tensioner, a base platform; and an adhesive pad. The single finger holder and tensioner are permanently attached to form a first assembly, and the base platform and the adhesive pad are combined to form a second assembly. The adhesive pad has a cover that when removed may be used to attach the second assembly to a mobile handheld device. The first assembly is easily attached to and removed from the second assembly by a user. The first assembly may be rotated 360 degrees relative to the second assembly, and is held snugly in place by the single finger tensioner. Several additional embodiments are presented. One alternate embodiment replaces the single finger holder by a two-finger holder; another embodiment has an accessory that attaches to the handlebars of a stationary bicycle.

### CROSS-REFERENCE TO RELATED APPLICATIONS

This application claims the benefit of the U.S. Provisional Patent Application No. 61/58276 filed Jan. 11, 2012 by the present inventor. This provisional patent application is incorporated herein by reference.

### BACKGROUND OF THE DISCLOSURE

The use of mobile handheld devices such as smart phones (e.g. Apple iPhone, Samsung Galaxy, Research in Motion Blackberry), eReaders (e.g. Amazon Kindle, Barnes and Noble Fire), tablets (e.g. iPad Mini) and GPS navigators (e.g. Garmen and TomTom products) are becoming increasingly popular. While all of these devices are easy to use with a built in keypad implemented in either hardware or software, they usually require the use of two hands to use the keypad on the device. Therefore, there is an increasing market for add-on accessories that allow the device to be used with one hand, typically by attaching something to the back of the device where one or more fingers secure the device, and the thumb is used to manipulate the keyboard. However, these accessories often limit the position of the user's hand relative to the device, are either flimsily made, difficult and expensive to manufacture, not attractive in appearance, and are not extendible to other uses (e.g. use it hands-free on a stationary bicycle). Therefore, there is a need for a product that overcomes all of these obstacles.

### SUMMARY OF THE DISCLOSURE

In the first embodiment of the present invention, the disclosure presents a mobile device holder that is comprised of four components: a holder, a tensioner, a base platform. and an adhesive pad. The single finger holder and tensioner are permanently attached to form a first assembly, and the base platform and the adhesive pad are combined to form a second assembly. The first assembly is easily attached to and removed from the second assembly by a user. The first assembly may be rotated degrees relative to the second assembly without being detached from the second assembly, and is held snugly in place by the single finger tensioner. The adhesive pad has a cover that when removed, exposes the adhesive that can be permanently attached to a mobile handheld device. Several additional embodiments are presented that replace the single finger holder. One alternate embodiment replaces the single finger holder by a two-finger holder, another embodiment has an accessory that attaches to the handlebars of a stationary bicycle.

### BRIEF DESCRIPTION OF THE DRAWINGS

FIG. 1 illustrates a perspective view of a first embodiment of the current invention attached to a smartphone.

FIGS. 2a through 2d illustrate perspective views of the four components of the first embodiment of the current invention.

FIG. 3 illustrates a perspective cross-section view of the first assembly of the first embodiment of the present invention.

FIG. 4 illustrates a perspective cross-section view of the second assembly of the first embodiment of the present invention.

FIG. 5a illustrates a cross-section view of the four components of the first embodiment of the present invention.

FIG. 5b illustrates a cross-section view of the two assemblies of the first embodiment of the present invention.

FIG. 6 illustrates a bottom perspective view of the first embodiment of the present invention.

FIG. 7a illustrates a bottom perspective view of the base component of the first embodiment of the present invention.

FIG. 7b illustrates a bottom view of the base component of the first embodiment of the present invention.

FIGS. 8a through 8d illustrate perspective views of the four components of a second embodiment of the current invention.

FIG. 9 illustrates a perspective view of a first embodiment of the present invention attached to a handlebar using an accessory.

FIG. 10 illustrates a the first assembly of a third embodiment of the present invention.

### NUMERALS

L1 first width

L2 second width

L3 third width

100 smart phone device

202 single finger mobile handle

203 cylinder slit

204 holder

205 single finger split cylinder

206 single finger tensioner

207 holder platform

208 base fastener

210 thin adhesive-backed circular pad

211 attachment part

212 first assembly

214 round disk

215 circular disk

216 pair of female slots

218 pair of male stubs

219 single finger tensioner base

220 single finger tensioner cylinder

222 base U-shaped slot

223 lip

224 disk U-shaped slot

226 thin slits

228 second assembly

302 double finger mobile handle

305 split cylinders

306 two finger tensioner

307 double finger holder platform

308 base fastener

310 thin adhesive-backed circular pad

312 single male stub

316 single female slot

402 accessory

404 handlebars

406 accessory grip component

408 accessory stub

502 top band

507 low profile holder platform

508 attachment mechanism

512 low profile first assembly

### DETAILED DESCRIPTION OF THE DISCLOSURE

In the following detailed description, the terms top and bottom of a part, component or assembly refers to top or bottom of the part, component, or assembly in the figure that it refers to. If more than one essentially identical part occurs in a figure, only one numeral may be referenced in the figure. The term cylinder is used to refer an object that has the general shape of a cylinder; it includes the “split cylinder” shape as discussed below.

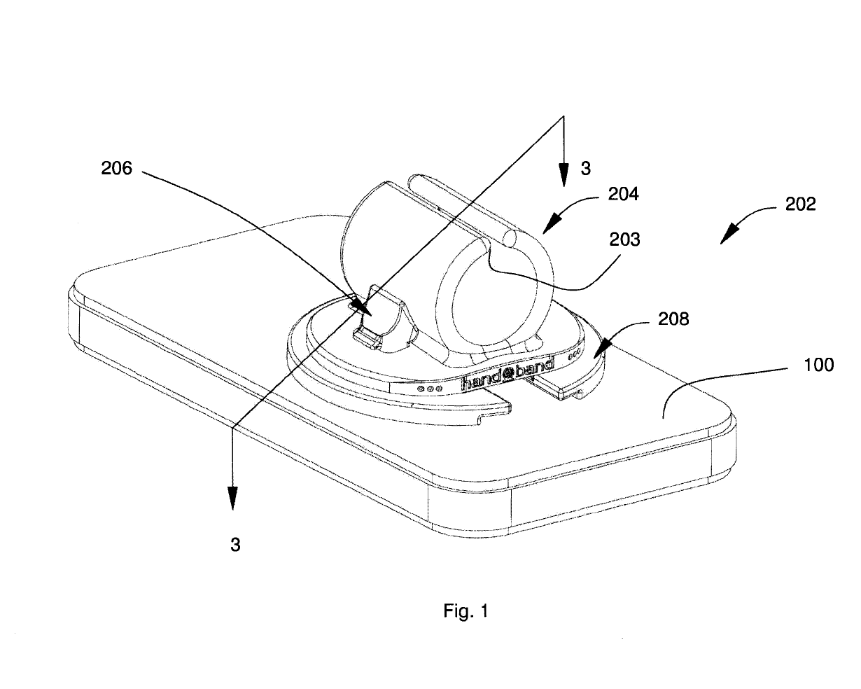

FIG. 1 illustrates the first embodiment, a single finger mobile handle 202 of the current invention attached to smart phone device 100. Single finger mobile handle 202 is constructed out of four components: a holder 204, a base fastener 208, a single finger tensioner 206 and a thin adhesive-backed circular pad 210 (thin adhesive-backed circular pad not shown in the FIG. 1) for attaching the base fastener 208 to smart phone device 100. Holder 204 is permanently attached to single finger tensioner 206 forming a semi-rigid component. Holder and tensioner together are removable attachable to base fastener 208.

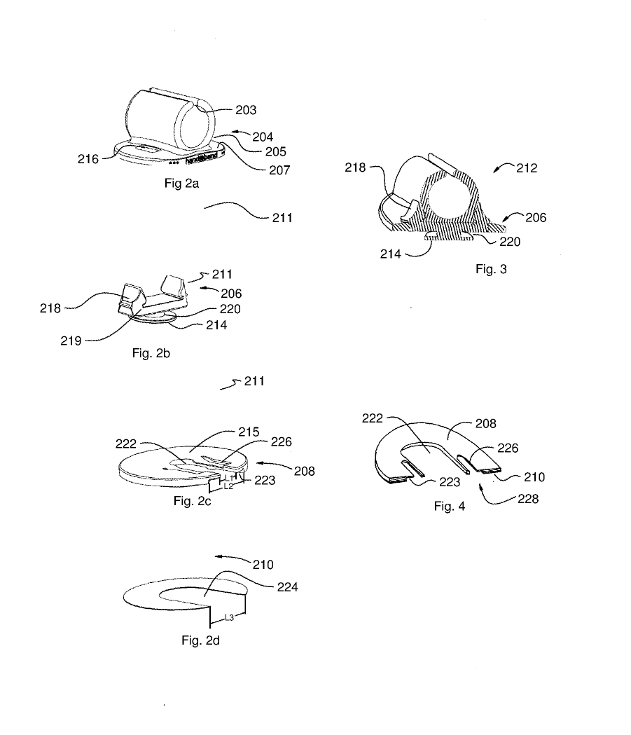

FIGS. 2a through 2d illustrates the components of single finger mobile handle 202 of the current invention. Referring to FIG. 2a, holder 204 has single finger split cylinder 205 with a cylinder slit 203, holder platform 207 and a pair of female slots 216.

Referring to FIG. 2b, single finger tensioner 206 has an attachment part 211 comprised of a pair of male stubs 218 attached to single finger tensioner base 219, a single finger tensioner cylinder 220 and round disk 214.

Referring to FIG. 2c, base fastener 208 has the shape of a circular disk 215, with base U-shaped slot 222 having first width L1 and a pair of thin slits 226. Referring to FIG. 2d, thin adhesive-backed circular pad 210 has a disk U-shaped slot 224 having second width L2. Top surface of thin adhesive-backed circular pad 210 is permanently attached to bottom of round disk 214. Bottom surface of thin adhesive-backed circular pad 210 has adhesive applied to it, with a removable cover. (Cover not shown in the figure). Although in the first embodiment, the bottom surface of thin adhesive-backed circular pad 210 has adhesive applied to it, alternate embodiments may use other means for attaching circular disk to smart phone, e.g. may have adhesive supplied separately, or may you other attaching mechanisms such as hook and loop, suction cups, or magnets.

Referring to FIGS. 2c and 2d, third width L3 of disk U-shaped slot 224 is sized so it does not cover the pair of thin slits 226. The single finger tensioner has two primary purposes; i) to provide resistance against the sides of the base U-shaped slot 222 to allow the base U-shaped slot to fit securely to the round disk 214, ii) to allow the holder 204 to be attached to the base fastener 208 so the holder may rotate a full 360 degrees in either rotational direction.

FIGS. 3 and 4 provide two cross section views. FIG. 3 is a cross section of holder 204 when assembled with single finger tensioner 206, forming a first assembly 212. FIG. 4 illustrates a cross section of base fastener 208 when assembled with thin adhesive-backed circular pad 210 forming a second assembly 228.

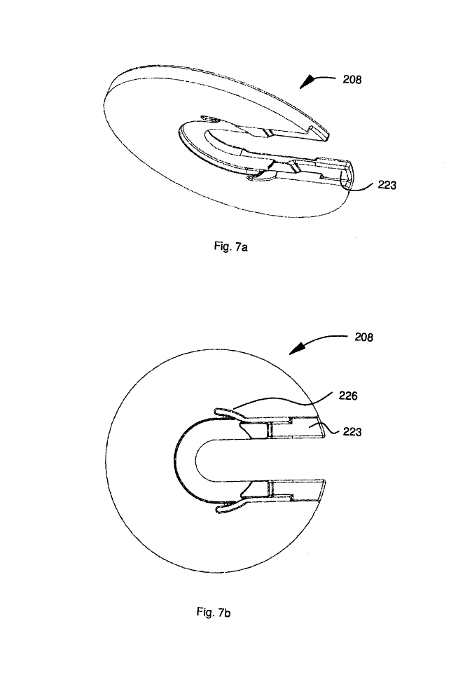

Referring to FIGS. 1 through 4, single finger mobile handle 202 is assembled as follows: Single finger tensioner 206 is permanently attached to holder 204 by forcing the pair of male stubs 218 through the pair of female slots 216, thus forming the first assembly 212. The top surface of thin adhesive-backed circular pad 210 is permanently attached to bottom of base fastener 208 using an adhesive (adhesive not shown in the figures), while aligning base U-shaped slot with disk U-shaped slot 224, thus forming the second assembly 228. Referring now to FIG. 6, first assembly 212 is rotationally attached to second assembly 228 by sliding the round disk 214 of second assembly 228 along lip 223.

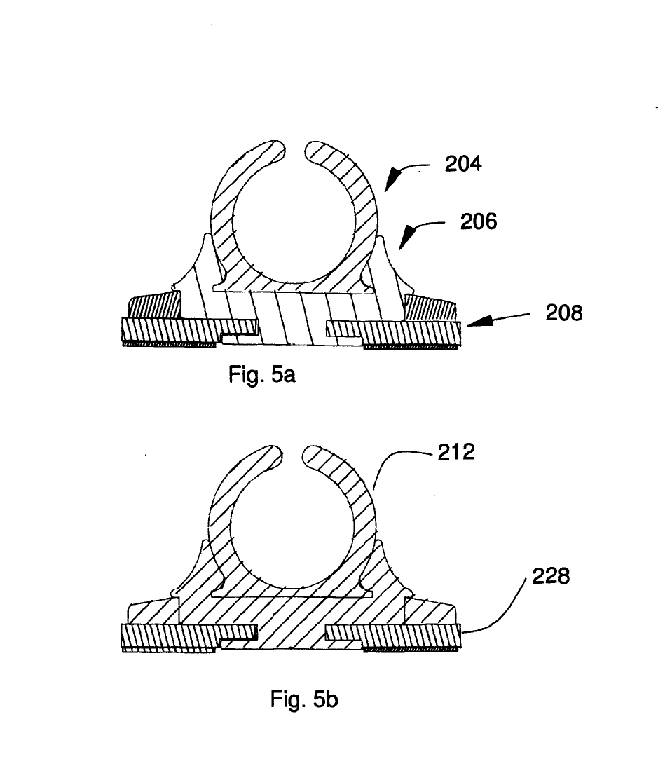

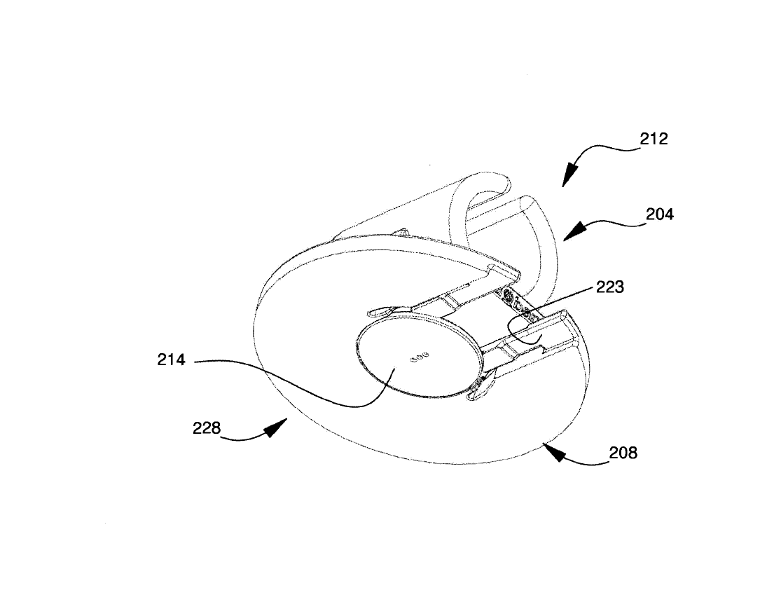

FIGS. 5a and 5b give two cross sectional views of the single finger mobile handle 202 of the first embodiment. FIG. 5a shows the four components of the single finger mobile handle 202: the holder 204, the single finger tensioner 206, the base fastener 208 and the thin adhesive-backed circular pad 210. FIG. 3b illustrates first assembly 212 and the second assembly 228.

FIG. 6 illustrates a perspective bottom view of single finger mobile handle 202. Referring to FIG. 6, the first assembly 212 is removably attached to the second assembly 228 by sliding the first assembly through the base U-shaped slot 222 with the round disk 214 fitting in the lip 223. The pair of thin slits 226 apply pressure against the single finger tensioner cylinder 220 (hidden and therefore not shown in FIG. 6.) to secure a tight fit.

To install the single finger mobile handle do the following:

Step A: Remove the adhesive backing from the back/bottom side of the second assembly 228 and adhere it to the back of your smart phone device 100 with the opening of the base U-shaped slot 222 facing in the 6 o'clock position. Press firmly and hold in place for 30 seconds. The assembly is best placed just below center (top to bottom) and middle (left to right) on most smart phones. For best results, wait at least one (1) hour before heavy usage.

Step B: Slip your middle finger into the holder 204 to a comfortable position above your knuckles.

Step C: Lift your smartphone upright and you're ready to go! The single finger mobile handle 202 can be rotated a full 360 degrees relative to the second assembly allowing you to use your handheld device in nearly any position you like.

FIGS. 7a and 7b illustrate a bottom perspective view and a bottom view respectively of the base fastener of the first embodiment of the current invention. Referring to FIGS. 6, 7a, and 7b, lip 223 is shown that accommodates the round disk 214 so that the round disk fits snugly into lip 223 as it slides along the lip as shown in FIG. 6, and has a thickness relative to the lip's height so the bottom of the round disk 214 is approximately flush with the bottom of lip 223. Therefore, when the single finger mobile handle is attached to the smart phone device 100, the bottom of the ring will not rub against the smart phone device.

Additional alternate embodiments are within the inventive concept of this invention. For example, the thin slits 226 illustrated in FIGS. 7a and 7b are designed to apply tension to the tensioner cylinder. However, they may be replaced by metal flat spring strips imbedded in the base fastener, in a manner that applies tension to the tensioner cylinder. Alternately, the thin slits 226 may be eliminated altogether, where the tension is accomplished by manufacturing the components to have a tight fit. Similarly, the cylinder slit 203 allow some flexibility to the single finger split cylinder 205. However, the cylinder slit 203 in split cylinder 204 may be eliminated. Although the embodiments presented herein apply to a smart phone device, they apply also to other mobile devices such as, but not limited to, tablets such as iPads, and GPS navigators such as produced by Garmin and TomTom, eReaders such as the kindle and Nook, and handheld digital cameras.

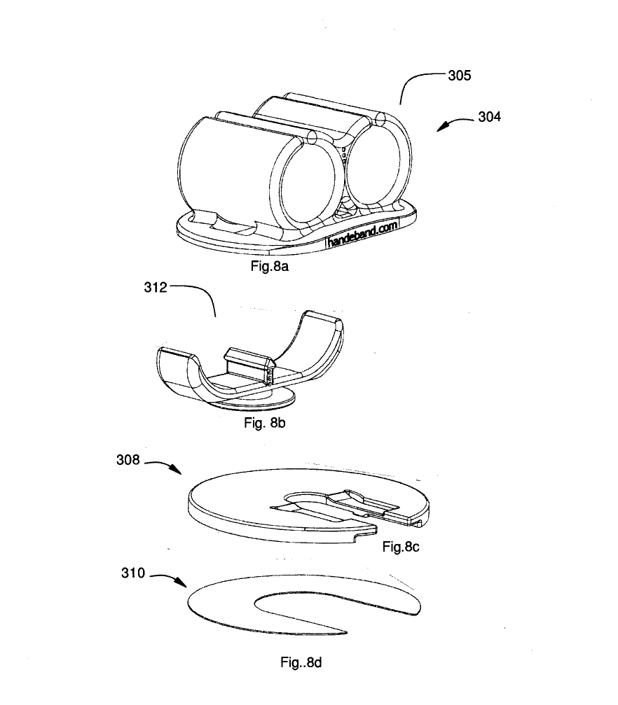

FIGS. 8a through 8d illustrate a second embodiment of the current invention It is similar to the first embodiment, except that it is used with two fingers instead of one. Only the significant differences between the first and second embodiments are discussed. The double finger mobile handle 302 with pair of split cylinders 305 replaces the single finger mobile handle 202, so it can accommodate two fingers. The two finger tensioner 306 has a single male stub 312 that attaches to the double finger mobile handle 302 through a single female slot 316 located on the double finger holder platform 307 (single female slot 316 is not shown in the FIG. 8a). The base fastener 308 and thin adhesive-backed circular pad 310 are identical to their single finger analogues.

In the first and second embodiments, the three components: holder, tensioner and base fastener are made out of nylon. However in alternate embodiments they be made out of plastic, TPR 90/95 shore, urethane, polypropylene, metal, rubber, glass, or other materials.

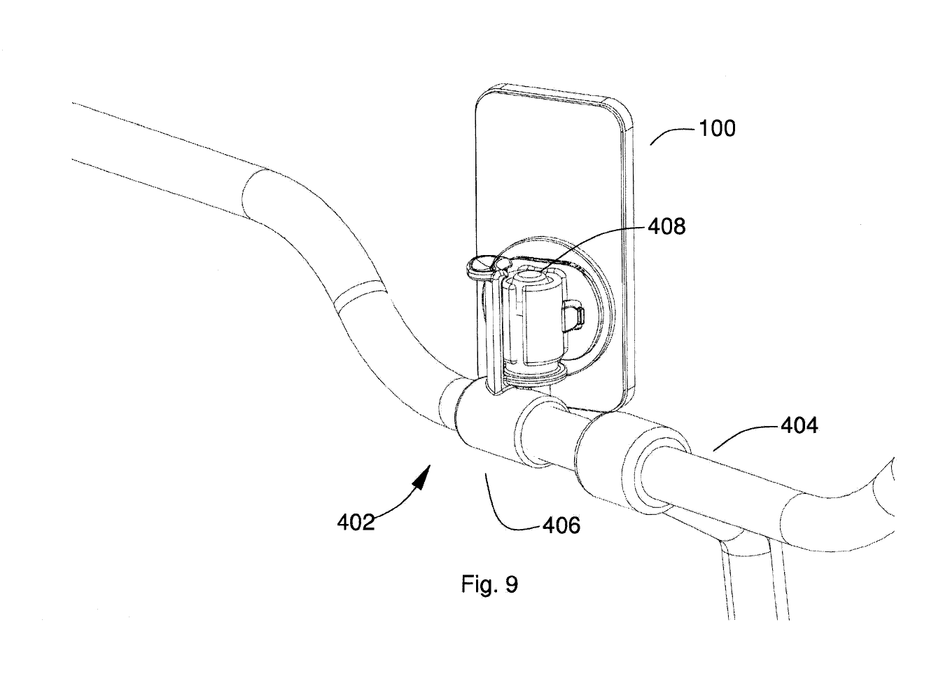

FIG. 9 illustrates the single finger mobile handle 202 attached to smart phone device 100 with an accessory 402 attached to handlebars 404 of a stationary bike. The accessory has a has two components: an accessory grip component 406 that attaches to the handlebars and an accessory stub 408 that attaches snugly inside the single finger split cylinder 205.

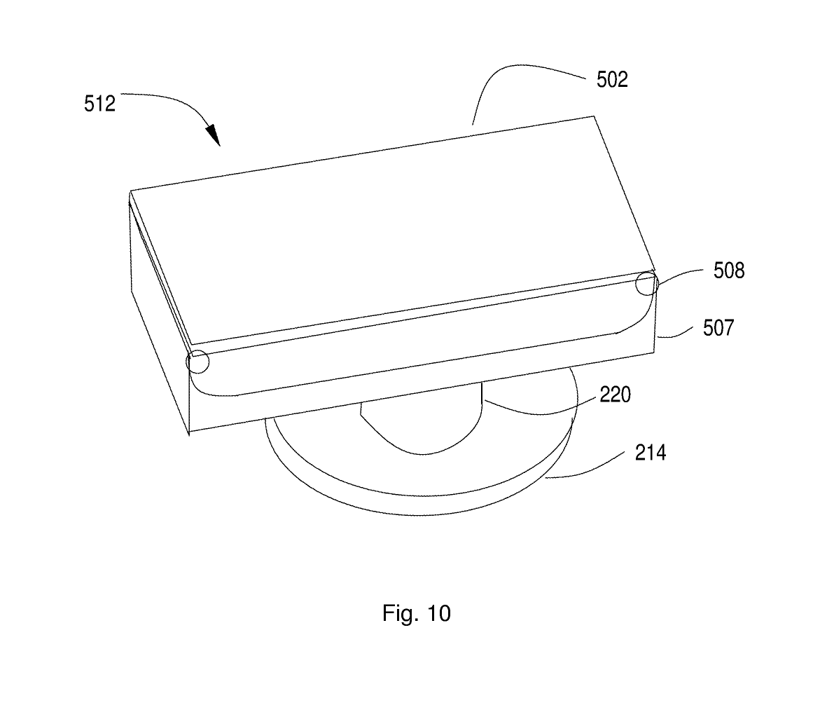

FIG. 10 illustrates the first assembly of a third embodiment of the present invention, called a low profile holder. It replaces the first assembly 212 of the first embodiment show in FIG. 5b. In this embodiment, there is no tensioner. The top band 502 is an elastic band made of silicone/rubber with an inner elastic reinforcement. The low profile holder platform 507 is attached to top band 502 by attachment mechanism 508 that allows one or more user fingers to slip through. The remaining parts: the cylinder 220 and the round disk 202 are the same as in FIG. 2b. In this embodiment, the second assembly is the same as the first embodiment as shown in FIGS. 2c, 2d and 5b. The low profile first embodiment 512 attaches to the second assembly 228 in the same way as the first embodiment does.

The disclosure presented herein gives multiple embodiments of the present invention. These embodiments are to be considered as only illustrative of the invention and not a limitation of the scope of the present invention. Various permutations, combinations, variations, and extensions of these embodiments are considered to fall within the scope of this invention. The sizes of the components are commercial design considerations, and the materials used in the components of the embodiment are also commercial design considerations.

I claim:

1. An apparatus attachable to a mobile handheld device, said apparatus comprising:
a first assembly, said first assembly having a means for accommodating at least one finger;
a second assembly, said second assembly comprised of:
a means for removably attaching said second assembly to said first assembly;
a means for rotating said first assembly at least 15 degrees in each rotational direction relative said second assembly when said second assembly is attached to said first assembly; and
a means for permanently attaching said second assembly to said mobile handheld device.

2. The apparatus of claim 1 wherein said means for rotating said first assembly permits rotation of 360 degrees in each rotational direction, relative said second assembly.

3. The apparatus of claim 2 wherein at said at least one cylinder is a single split cylinder.

4. An apparatus capable of being attached to a mobile handheld device, said apparatus comprising:
a first assembly, said first assembly comprising:
a holder, said holder having a means for accommodating at least one finger;
a tensioner, said tensioner attached to said holder;
a second assembly, said second assembly comprised of:
a base fastener, said base fastener removably, rotationally attachable to said first assembly, and wherein when said base fastener being rotationally attached to said holder, said first assembly base fastener is rotatable at least 15 degrees in each rotational direction relative to said first assembly.

5. The apparatus for claim 4 wherein said at least one cylinder is comprised of at least one split cylinder.

6. The apparatus of claim 4 wherein said means for rotating said first assembly permits rotation of 360 degrees in each rotational direction, relative to said second assembly.

7. An apparatus capable of being attached to a mobile handheld device, said apparatus comprising:
a first assembly, said first assembly comprising:
a holder, said holder comprised of:
at least one cylinder;
a holder platform, wherein said at least one cylinder is attached to said holder platform; said holder platform additionally having at least one female slot,
a tensioner, said tensioner comprised of:
an attachment part, said attachment part comprised of at least one male stub and a tensioner base;
a tensioner cylinder having a top and a bottom, and
a thin disk having a top and a bottom,
wherein said top of said thin disk is attached to said bottom of said tensioner cylinder, and said top of said tensioner cylinder is attached to said bottom of said tensioner base wherein said holder is attached to said tensioner;
a second assembly, said second assembly comprised of:
a base fastener, said base fastener having the shape of a disk, said base fastener additionally having a base U-shaped slot; said base fastener additionally having a lip positioned at the bottom of said base U-shaped slot; and
wherein said second assembly is rotationally attachable to said first assembly by sliding said tensioner cylinder into said base U-shaped slot with said round disk fitting snugly into said lip.

8. The apparatus of claim 7 where said second assembly is additionally comprised of a thin adhesive-backed circular pad having a disk U-shaped slot wherein said thin adhesive-backed circular pad is attached to said base fastener and wherein said thin adhesive-backed circular pad is additionally permanently attachable to said mobile handheld device.

9. The apparatus of claim 7 wherein said at least one cylinder is comprised of at least one split cylinder.

10. The apparatus of claim 7 wherein said first assembly is rotatable relative to said second assembly of at least 15 degrees in each rotational direction, relative said first assembly.

11. The apparatus of claim 10 wherein said first assembly is rotatable relative to said second assembly 360 degrees in each rotational direction, relative said first assembly.

12. The apparatus of claim 7 wherein the components of the first assembly and the base fastener of the second assembly are made from materials selected from the group consisting of nylon, TPR 90/95 shore, urethane, polypropylene, and a combination thereof.
